(19) United States
(12) Patent Application Publication
(10) Pub. No.: US 2021/0096774 A1
(43) Pub. Date: Apr. 1, 2021

(54) DATA STORAGE DEVICE AND METHOD OF OPERATING THE SAME

(71) Applicant: SK hynix Inc., Icheon-si Gyeonggi-do (KR)

(72) Inventors: Gi Bbeum HAN, Icheon-si Gyeonggi-do (KR); Kyung Bum KIM, Icheon-si Gyeonggi-do (KR); Ji Man HONG, Icheon-si Gyeonggi-do (KR); Na Ra SHIN, Icheon-si Gyeonggi-do (KR)

(73) Assignee: SK hynix Inc., Icheon-si Gyeonggi-do (KR)

(21) Appl. No.: 16/870,422

(22) Filed: May 8, 2020

(30) Foreign Application Priority Data
Sep. 30, 2019 (KR) 10-2019-0120472

(51) Int. Cl. G06F 3/06; G06F 12/10

(52) U.S. Cl. CPC G06F 3/0659; G06F 12/10; G06F 3/0619; G06F 3/0679

(57) ABSTRACT

A data storage device may include a storage and a controller. The storage includes a plurality of memory cells. The controller is configured to map a logical address of a host on a first physical address of the storage to perform data exchanges with respect to the storage. The controller includes an address error management component. The address error management component is configured to generate a first checker based on the first physical address. The address error management component transmits the first checker and the first physical address to the storage. When an address error occurs in the first physical address based on an address error check information that is transmitted from the storage, the address error management component is configured to remap the logical address on a second physical address.

### CROSS-REFERENCES TO RELATED APPLICATION

The present application claims priority under 35 U.S.C. § 119(a) to Korean application number 10-2019-0120472, filed on Sep. 30, 2019, in the Korean Intellectual Property Office, which is incorporated herein by reference in its entirety.

### BACKGROUND

### 1. Technical Field

Various embodiments may generally relate to a semiconductor device, more particularly, a data storage device and a method of operating the data storage device.

### 2. Related Art

A data storage device may be connected to a host device to perform data input/output operations based on the requests from the host device. The data storage device may include various storage mediums that are configured to store the data. For example, the storage medium may include a non-volatile memory device such as a flash memory device.

Fine pattern processes that improve the integration degree of the data storage device and complications of a hardware and a software in an electronic device may cause a narrow width of a line, decreasing the reliability of the memory device. In order to ensure high reliability of the memory device to combat the increasing number of errors of the memory device, it may be required to accurately detect the error that is generated in operating the memory device.

### SUMMARY

In example embodiments of the present disclosure, a data storage device may include a storage and a controller. The storage may include a plurality of memory cells. The controller may be configured to map a logical address of a host on a first physical address of the storage to perform data exchanges with respect to the storage. The controller may include an address error management component. The address error management component may be configured to generate a first checker based on the first physical address. The address error management component may transmit the first checker and the first physical address to the storage. When an address error occurs in the first physical address based on an address error check information that is transmitted from the storage, the address error management component may be configured to remap the logical address on a second physical address.

In example embodiments of the present disclosure, a data storage device may include a controller and a storage. The controller may be configured to map a logical address of a host on a first physical address of the storage in response to a command process request of the host. The controller may be configured to transmit a first checker, which is generated based on the first physical address, transmitting the first checker with the first physical address to the storage. The storage may include a plurality of memory cells. The storage may be configured to compare the first checker with a second checker to generate an address error check information. The second checker is generated based on the first physical address. The controller remaps the logical address on a second physical address when an address error occurs in the first physical address, which is determined based on the address error check information that is transmitted from the storage.

In example embodiments of the present disclosure, according to a method of operating a data storage device, the data storage device may include a storage and a controller. The controller may be configured to map a logical address of a host on a first physical address of the storage to perform data exchanges with respect to the storage. The controller may generate a first checker based on the first physical address. The controller may include the first checker in the first physical address. The controller may transmit the first checker with the first physical address to the storage. The storage may generate a second checker based on the first physical address that is received from the controller. The storage may transmit an address error check information, which may be generated by comparing the first checker with the second checker, to the controller. The controller may identify whether an address error is generated, which is determined based on the address error check information. When the address error is generated, the controller may remap the logical address on a second physical address.

### BRIEF DESCRIPTION OF THE DRAWINGS

The above and another aspects, features and advantages of the subject matter of the present disclosure will be more clearly understood from the following detailed description taken in conjunction with the accompanying drawings, in which:

FIG. 1 is a view, illustrating a data storage device, in accordance with example embodiments;

FIG. 2 is a view, illustrating a memory controller, in accordance with example embodiments;

FIG. 3 is a view, illustrating an address error management component, in accordance with example embodiments;

FIG. 4 is a view, illustrating a non-volatile memory device in a data storage device, in accordance with example embodiments;

FIG. 5 is a flow chart, illustrating a method of operating a data storage device, in accordance with example embodiments;

FIGS. 6 and 7 are views, illustrating internal operations of a storage, in accordance with example embodiments; and

FIG. 8 is a view, illustrating an addressing concept, in accordance with example embodiments.

FIG. 9 is a diagram, illustrating a data storage system, in accordance with an embodiment.

FIG. 10 and FIG. 11 are diagrams, illustrating a data processing system, in accordance with an embodiment.

FIG. 12 is a diagram, illustrating a network system including a data storage device, in accordance with an embodiment.

### DETAILED DESCRIPTION

Various embodiments of the present invention will be described in greater detail with reference to the accompanying drawings. The drawings are schematic illustrations of various embodiments (and intermediate structures). As such, variations from the configurations and shapes of the illustrations as a result, for example, of manufacturing techniques and/or tolerances, are to be expected. Thus, the described embodiments should not be construed as being limited to the particular configurations and shapes illustrated herein but may include deviations in configurations and shapes which do not depart from the spirit and scope of the present invention as defined in the appended claims.

The present invention is described herein with reference to cross-section and/or plan illustrations of idealized embodiments of the present invention. However, embodiments of the present invention should not be construed as limiting the inventive concept. Although a few embodiments of the present invention will be shown and described, it will be appreciated by those of ordinary skill in the art that changes may be made in these embodiments without departing from the principles and spirit of the present invention.

It will be understood that although the terms “first”, “second”, “third” etc. are used herein to describe various elements, these elements should not be limited by these terms. These terms are only used to distinguish one element from another element. Thus, a first element in some embodiments could be termed a second element in other embodiments without departing from the teachings of the present disclosure.

Further, it will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

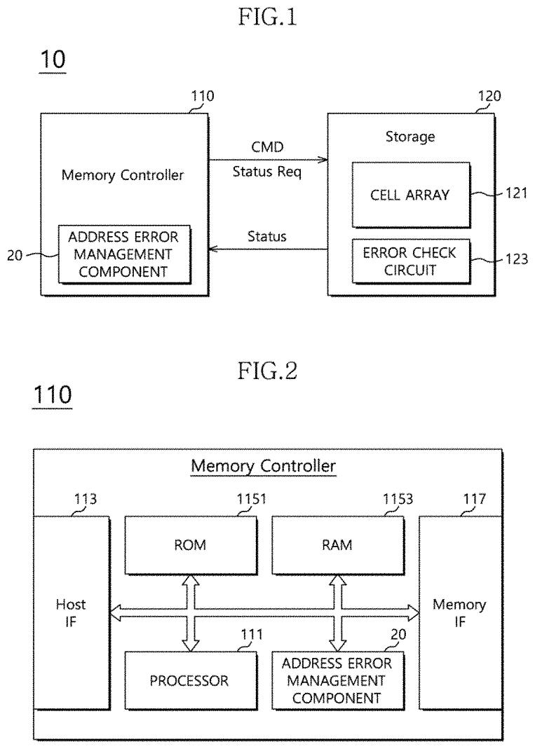

FIG. 1 is a view, illustrating a data storage device, in accordance with example embodiments.

Referring to FIG. 1, a data storage device 10 may include a controller 110 and a storage 120.

The controller 110 may be configured to control the storage 120 based on requests from the host device. For example, the controller 110 may control the storage 120 to program data in the storage 120 based on a write request from the host device. The controller 110 may provide the host device with the data in the storage 120 based on a read request from the host device. The controller 110 may include an address error management component 20.

The storage 120 may be configured to store and/or output data based on the requests of the controller 110. The storage 120 may include a volatile memory device or a non-volatile memory device. For example, the storage 120 may be configured using a memory device. For example, the memory device may be an electrically erasable and programmable ROM (EEPROM), a NAND flash memory, a NOR flash memory, a phase change RAM (PRAM), a resistive RAM (ReRAM), a ferroelectric RAM (FRAM), a spin torque transfer magnetic RAM (STT-MRAM), etc. The storage 120 may include a plurality of dies Die 0˜Die n, a plurality of chips, a plurality of packages, etc. Further, the storage 120 may be operated as a single level cell that is configured to store one bit of data in one memory cell, or a multi-level cell that is configured to store bits of data in one memory cell.

In example embodiments, the storage 120 may include a cell array 121 and an error check circuit 123. The cell array 121 may include a plurality of non-volatile memory cells.

The cell array 121 may include a plurality of memory cells that are connected between a plurality of word lines and a plurality of bit lines.

The controller 110 may transmit commands CMD, such as a program command, an erase command, a read command, etc., to the storage 120. The storage 120 may process an operation that corresponds to the commands that are received from the controller 110. The controller 110 may request status information (Status Req) after transmitting the commands. In example embodiments, the status information request (Status Req) may transmit using a status read command. The storage 120 may transmit the status information (Status) in response to the status information request (Status Req) so that the controller 110 may identify whether or not the commands CMD is normally performed.

In example embodiments, the controller 110 may generate a first checker with respect to an address of a memory cell to perform an operation corresponding to the command when transmitting the command. The controller 110 may involve the first checker in the address. The controller 110 may then transmit the address with the checker to the storage 120.

The error check circuit 123 of the storage 120 may be configured to generate a second checker from the address that is received with the command. The error check circuit 123 may generate the second checker in substantially the same way as generating the first checker.

The error check circuit 123 may identify whether the second checker, generated by the error check circuit 123, is equal to the first checker that is transmitted from the controller 110. The error check circuit 123 may involve an identified result in the status information (Status). The error check circuit 123 may then transmit the status information (Status) with the identified result to the controller 110. In example embodiments, the status information (Status) may be transmitted as a plurality of bits. A specific bit position of the plurality of bits may be allotted to an error check bit.

When the second checker is different from the first checker, the storage 120 may recognize a generation of an address error. The storage 120 may stop a command process with respect to the corresponding address. The storage 120 may transmit the status information (Status), including a predetermined logic level of an address check bit, to the controller 110.

The controller 110 may identify whether or not the address error is generated at the address, transmitted with the command, based on the status information (Status), received from the storage 120. When the address error is generated, the controller 110 may be configured to change the previous address to a new address to perform the command. The controller 110 may control the storage 120 to access to the changed new address and process the command.

In example embodiments, after transmitting the status information (Status), the storage 120 may transmit the received address, including an error, to the controller 110. The controller 110 may store the previous address, transmitted to the storage 120, and the address, changed due to an error provided from the storage 120, as debugging information.

Therefore, the controller 110 may transmit the address, including the first checker to the storage 120, when transmitting the command to the storage 120. The storage 120 may identify whether or not the address is normally received based on the address that is received from the controller 110, the first checker and the second check being generated by the storage 120.

Because the error check result with the status information (Status) of the storage 120 may be transmitted to controller 110, the controller 110 may re-designate the address and may request processing the command again when an address error occurs.

Further, because the storage 120 may provide the controller 110 with the address that is changed by the error generation, the controller 110 may store the initially access-requested address and the changed address as the debugging information. Therefore, errors of input/output paths in storage 120 may be identified by the debugging information from an external device, such as a test device.

FIG. 2 is a view, illustrating a memory controller, in accordance with example embodiments.

Referring to FIG. 2, the controller 110 may include a processor 111, a host interface 113, a ROM 1151, a RAM 1153, a memory interface 117, and an address error management component 20.

The processor 111 may provide the host interface 113, the RAM 1153, and the memory interface 117 with various control information that are required to perform a read operation or a write operation of the data with respect to the storage 120. In example embodiments, the processor 111 may be operated based on firmwares that are provided for various operations of the data storage device 10. The processor 111 may perform a function of a flash translation layer (FTL) that includes various functions for managing the storage 120 and a function of detecting and correcting error read from the storage 120.

The FTL may have a function to provide a garbage collection, an address mapping, a wear leveling, etc., a function for managing properties of each of memory blocks in the storage 120.

The host interface 113 may receive the commands and clock signals from the host device according to a controlling of the processor 111. The host interface 113 may be connected to the host device through communicating channels that control the inputting/outputting of data.

Particularly, the host interface 113 may provide a physical connection between the host device and the data storage device 10. The host interface 113 may interface with the data storage device 10 that corresponds to a bus format of the host device. The bus format of the host device may include at least one of the standard interface protocols such as a secure digital, a universal serial bus (USB), a multi-media card (MMC), an embedded MMC (eMMC), a personal computer memory card international association (PCMCIA), a parallel advanced technology attachment (PATA), a serial advanced technology attachment (SATA), a small component interconnection (PCI), a PCI express (PCI-E), a universal flash storage (UFS), etc.

The ROM 1151 may store program codes, such as firmware or software, required for operating the controller 110. The ROM 1151 may also store code data used by the program codes.

The RAM 1153 may store data that is required to operate the controller 110 and data that is generated by the controller 110.

The memory interface 117 may provide communication channels through which signals may be transmitted between the controller 110 and the storage 120. The memory interface 117 may transmit data that is temporarily stored in a buffer memory to the storage 120 according to a controlling of the processor 111. The memory may transmit data, read from the storage 120, to the buffer memory to temporarily store the data.

The address error management component 20 may extract a physical address of the storage 120, corresponding to a logical address access-requested by the host device, in response to a command process request of the host device. The address error management component 20 may generate the first checker from the extracted physical address. The address error management component 20 may use the first checker in the address to process the command. The address error management component 20 may then transmit the address with the first checker to the storage 120.

The address error management component 20 may identify the status information (Status) that is received from the storage 120. When the address error is generated, the address error management component 20 may remap the logical address, access-requested by the host device, on a physical address. The address error management component 20 may transmit the command to access the remapped physical address. Here, the address error management component 20 may generate the first checker with respect to the remapped physical address. The first check may be transmitted together with the address.

The address, changed by the address error, may be transmitted to the controller 110 so that the address error management component 20 may store the initially access-requested address and the changed address as the address error information.

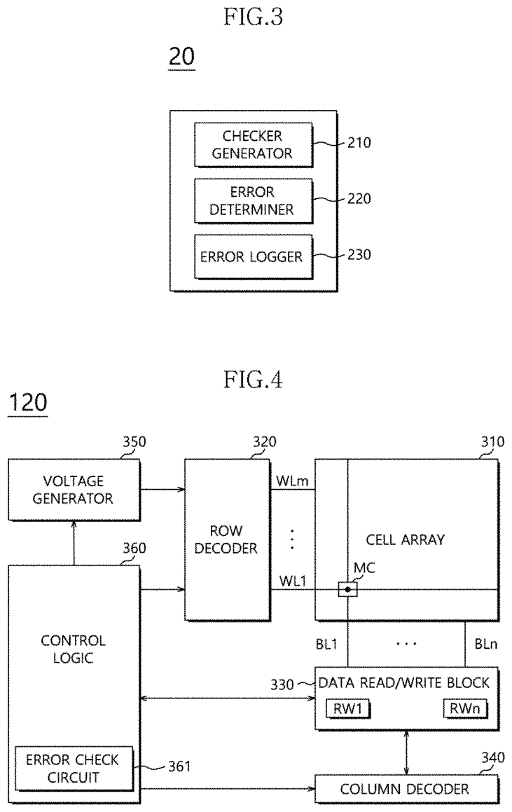

FIG. 3 is a view, illustrating an address error management component, in accordance with example embodiments.

Referring to FIG. 3, the address error management component 20 may include a checker generator 210, an error determiner 220, and an error logger 230.

The checker generator 210 may extract the physical address that corresponds to the access-requested logical address to process the command. The checker generator 210 may then generate the first checker with respect to the extracted physical address.

In example embodiments, the physical address may be transmitted between the controller 110 and the storage 120 through input/output pads in a plurality of cycles. The physical address, through each of the cycles, may be transmitted in a plurality of bits. The checker generator 210 may perform an XOR operation of address bits in the same bit position by each of the cycle to generate an odd or even parity bit. The checker generator 210 may use the parity bit as the first checker. However, the invention is not limited thereto.

The error determiner 220 may determine whether or not the address error is generated based on the status information (Status) that is transmitted from the storage 120. In example embodiments, the status information (Status) may be transmitted as a plurality of bits. The specific bit position of the plurality of bits may be allotted to the address error check bit. When the address error check bit of the status information (Status) has a specific logical level, the error determiner 220 may generate an address error.

When the address error is generated based on the determination of the error determiner 220, the error logger 230 may store the initially access-requested address to process the command and the address, transmitted from the storage 120, as the address error information. For example, the address error information may be stored in the RAM 1153. However, the invention is not limited thereto. For example, the address error information may be stored in an additional storage space of the address error management component 20.

FIG. 4 is a view, illustrating a non-volatile memory device in a data storage device, in accordance with example embodiments.

Referring to FIG. 4, a non-volatile memory device 300 may include a memory cell array 310, a row decoder 320, a data read/write block 330, a column decoder 340, a voltage generator 350, and a control logic 360.

The memory cell array 310 may include memory cells MC that are located where the word lines WL1˜WLm and bit lines BL1˜BLn intersect.

The memory cell array 310 may include a two-dimensional or a three-dimensional memory cell array. The three-dimensional memory cell array may have a structure that is stacked in a direction that is substantially perpendicular to a flat surface of a semiconductor substrate, including a NAND string where at least one memory cell may be vertically positioned over another memory cell. Alternatively, the three-dimensional memory cell array may have a structure having horizontal directionality with a high degree of integration.

The row decoder 320 may be connected to the memory cell array 310 through the word lines WL1˜WLm. The row decoder 320 may operate based on the outputs of the control logic 360. The row decoder 320 may decode an address that is provided from the external device. The row decoder 320 may select and drive word lines WL1˜WLm based on decoded results. For example, the row decoder 320 may provide the word lines WL1˜WLm with word line voltages that are supplied from the voltage generator 350.

The data read/write block 330 may be connected to the memory cell array 310 through the bit lines BL1˜BLn. The data read/write block 330 may include read/write circuits RW1˜RWn that correspond to the bit lines BL1˜BLn, respectively. The data read/write block 330 may be operated based on the outputs of the control logic 360. The data read/write block 330 may be operated as a write driver or a sense amplifier based on operational modes. For example, the data read/write block 330 may be operated as the write driver, configured to store data, provided from the external device in the memory cell array 310 in a write mode. Further, the data read/write block 330 may be operated as the sense amplifier that is configured to read the data from the memory cell array 310 in a read mode.

The column decoder 340 may be operated based on outputs of the control logic 360. The column decoder 340 may decode the address that is provided from the external device. The column decoder 340 may connect the read/write circuits RW1˜RWn of the data read/write block 330, corresponding to the bit lines BL1˜BLn, respectively, to the data input/output lines or data input/output buffers based on the decoded results.

The voltage generator 350 may generate voltages that are used for a background operation of the non-volatile memory device 300. The voltages, generated by the voltage generator 350, may be applied to memory cells of the memory cell array 310. For example, a program voltage, generated in a program operation, may be applied to a word line of memory cells to perform the program operation. Further, an erase voltage, generated in an erase operation, may be applied to a well-region of the memory cells to perform the erase operation. A read voltage, generated in a read operation, may be applied to a word line of the memory cells to perform the read operation.

The control logic 360 may control all of the operations of the non-volatile memory device 300 based on control signals from the external device. For example, the control logic 360 may control the read operation, the write operation, and the erase operation of the non-volatile memory device 300.

The control logic 360 may include an error check circuit 361.

The error check circuit 361 may receive an address to process the command from the controller 110. The error check circuit 361 may generate the second checker based on the transmitted address. The address, transmitted from the controller 110, may include the first checker. The error check circuit 361 may compare the second checker with the first checker in the address to generate the address error check information. When the second checker is different from the first checker, i.e., the address error may be generated, the error check circuit 361 may notify the control logic 360 with regard to the address error to stop the processing of the command. The error check circuit 361 may set an address error check bit of the status information (Status) as a specific logic level. The error check circuit 361 may then transmit the address error check bit to the controller 110. In example embodiments, when the address error is generated, the error check circuit 361 may transmit the received address, i.e., the address changed by the error to the controller 110. For example, the address error may be generated by a bit flip. However, the invention is not limited thereto.

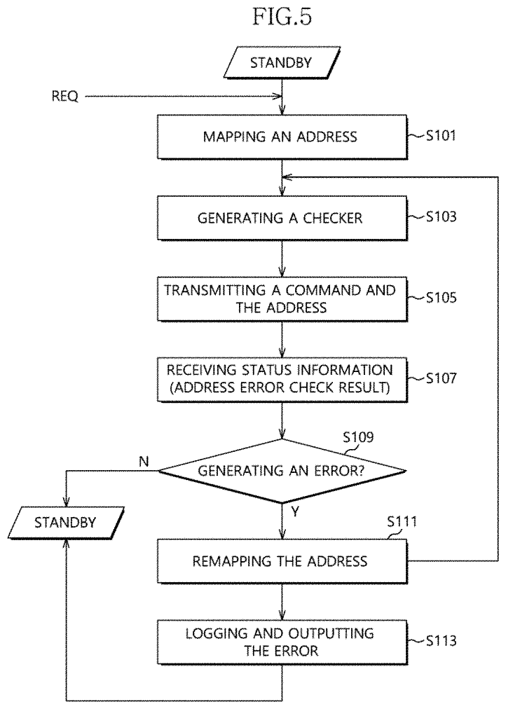

FIG. 5 is a flow chart, illustrating a method of operating a data storage device, in accordance with example embodiments.

Referring to FIG. 5, when the host device requests the command process REQ to the controller 110 of the data storage device 10, the controller 110 may map the logical address to request the command process by the host device on the physical address of the storage 120 in step S101.

In step S103, the controller 110 may generate the first checker based on the mapped physical address. In example embodiments, the physical address may be transmitted through the plurality of cycles by the plurality of bits. The controller 110 may perform an XOR operation of the address bit in the same bit position based on the cycle to generate the odd or even parity bit. The controller 110 may use the parity bit as the first checker, not restricted within the above manner. The first checker may be involved in the physical address.

In step S105, the controller 110 may transmit the address, including the first checker to the storage 120, to request the command process.

In step S107, the storage 120 may generate the second checker in response to the command and the address that are received from the controller 110. The second checker may be generated in substantially the same way as the first checker. Comparison results between the second checker and the first checker may be generated as the error check bit.

When the controller 110 requests the status information to the storage 120, the storage 120 may transmit the status information (Status), including the error check bit, to the controller 110.

In step S109, the controller 110 may identify whether or not the address error is generated based on the error check bit of the status information (Status).

When the address error is not generated, the controller 110 may be on standby for a following operation. In contrast, when the address error is generated, in step S111, the controller 110 may remap a new physical address to transmit the command to the storage 120.

When the address error is generated, in step S113, the storage 120 may transmit the address, changed based on the address error, to the controller 110. The controller 110 may store the initial address and the changed address as the error log. The error log may be outputted to the external device, such as the test device.

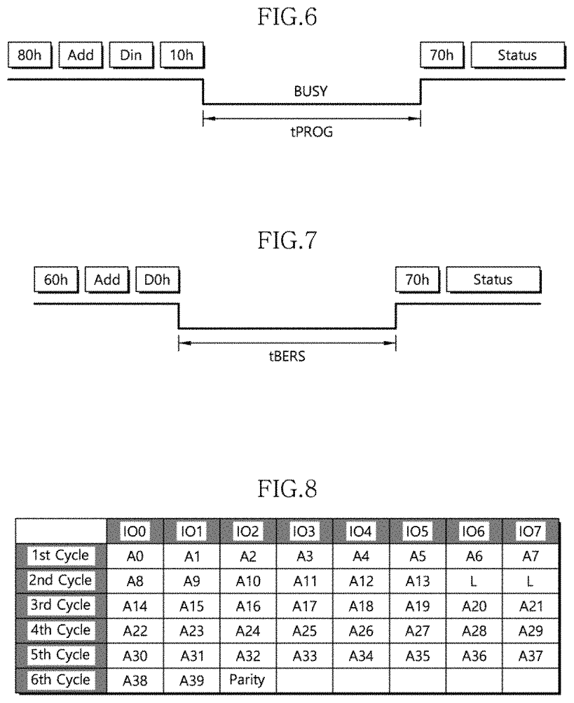

FIGS. 6 and 7 are views, illustrating internal operations of a storage, in accordance with example embodiments.

FIG. 6 illustrates the program operation. Referring to FIG. 6, after a first program command 80h is issued from the controller 110 to the storage 120 during the program operation, the address Add and the data Din may be sequentially inputted. The address Add may include a row address and a column address. When a second program command 10h is inputted to perform the program operation, a ready/busy signal may be transited at a low level. Data that is latched in a page buffer may be written in the memory cell during a busy period tPROG in which the program operation may be performed in the storage 120. When the ready/busy signal is transited to a high level after the busy period at which the program operation is completed, the controller 110 may transmit a status read command 70h. The storage 120 may transmit the status information (Status) to the controller 110 in response to the status read command 70h to identify whether or not the program operation is normally performed.

The first checker may be transmitted to the storage 120 along with the address Add. The storage 120 may generate the second checker from the address Add. The storage 120 may compare the second checker to the first checker.

The storage 120 may transmit the status information (Status), along with the comparison results between the first checker and the second checker, to the controller 110 by transmitting the status read command from the controller 110 to the storage 120.

As mentioned above, the controller 110 may identify the error check bit in the status information. When the address error is generated, the controller 110 may remap the physical address to again request the command process. Further, the controller 110 may store the initial access-requested address and the changed address as the error log by transmitting the address that is changed by the error generation.

FIG. 7 illustrates the erase operation. Referring to FIG. 7, after an erase program command 60h is issued from the controller 110 to the storage 120 in the erase operation, the address Add and the data Din may be sequentially inputted. Because the erase operation may be performed by a block unit, the address Add may include the row address. A second erase command D0h may be inputted to perform the erase operation. The ready/busy signal may be transited to a low level. Data that is written in the memory cell may be erased during a busy period tBERS in which the erase operation may be performed in the storage 120. After completing the erase operation, the ready/busy signal may be transited to a high level. The controller 110 may then transmit the status read command 70h. The storage 120 may transmit the status information Status to the controller 110 in response to the status read command 70h to identify whether or not the erase operation is normally performed.

The first checker may be transmitted to the storage 120 along with the address Add. The storage 120 may generate the second checker based on the address Add. The storage 120 may compare the second checker with the first checker. The storage 120 may transmit the status information (Status), along the comparison results between the first checker and the second checker, to the controller 110.

As mentioned above, the controller 110 may identify the error check bit in the status information. When the address error is generated, the controller 110 may remap a new physical address to again request the command process. Further, the controller 110 may store the initial access-requested address and the changed address as the error log.

FIG. 8 is a view, illustrating an addressing concept, in accordance with example embodiments.

The address may be transmitted through the input/output pads IO[0:7] through the plurality of cycles.

Referring to FIG. 8, the physical address may include a column address A[13:0] and a row address A[39:14]. The row address may include a word line address A[23:14], a plane address A[25:24], a block address A[36:26], and a logic storage region (LUN) address A[39:37].

The physical address may be outputted for the six cycles in FIG. 8, not restricted within a specific cycle. A physical address signal, transmitted in one cycle, may be approximately 8 bits. The number of address cycles for addressing the storage 120 and number of address bits that are transmitted in one cycle may be changed based on the size of the storage 120.

An unused bit of the address signal may be transmitted along with the parity information, i.e., the first checker. The first checker may be a one-bit signal, not restricted within a specific bit.

When an operation resumes after a program suspension, the address error may be generated due to the bit flip. When the bit flip is generated at only one bit of the address, the address may be accessed to an undesired position so that the data storage device may have low reliability.

According to example embodiments, the controller 1120 may transmit the address with the first checker, used for checking the address error, to the storage 120. The storage 120 may generate the second checker from the received address to generate the address error check bit. The storage 120 may transmit the status information, including the error check bit, in response to the status information read request after the command process. When the address error is generated, the controller 110 may remap the physical address to again request the command process. The controller 110 may log the address error information used in the debugging.

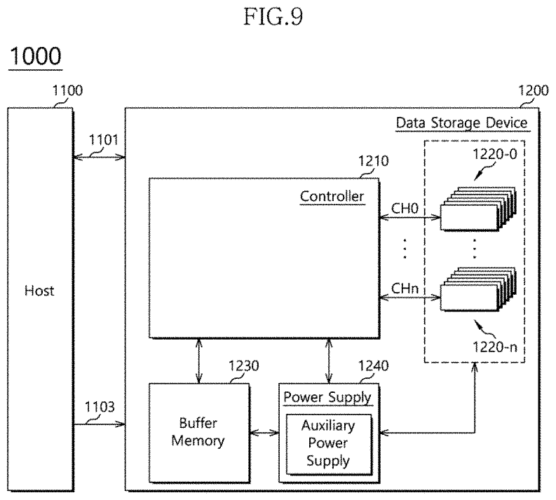

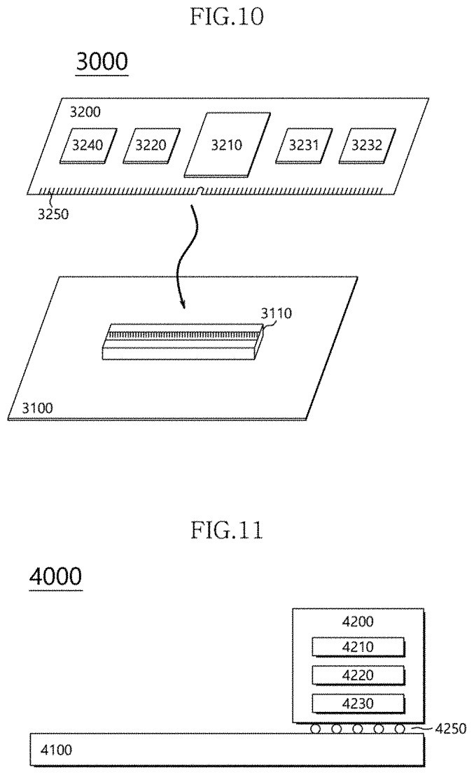

FIG. 9 is a diagram, illustrating a data storage system 1000, in accordance with an embodiment.

Referring to FIG. 9, the data storage 1000 may include a host device 1100 and the data storage device 1200. In an embodiment, the data storage device 1200 may be configured as a solid state drive (SSD).

The data storage device 1200 may include a controller 1210, a plurality of nonvolatile memory devices 1220-0 to 1220-n, a buffer memory device 1230, a power supply 1240, a signal connector 1101, and a power connector 1103.

The controller 1210 may control general operations of the data storage device 1200. The controller 1210 may include a host interface unit, a control unit, a random access memory used as a working memory, an error correction code (ECC) unit, and a memory interface unit. In an embodiment, the controller 1210 may be configured as the controller 110, shown in FIGS. 1 and 2.

The host device 1100 may exchange a signal with the data storage device 1200 through the signal connector 1101. The signal may include a command, an address, data, and so forth.

The controller 1210 may analyze and process the signal that is received from the host device 1100. The controller 1210 may control the operations of internal function blocks based on firmware or software to drive the data storage device 1200.

The buffer memory device 1230 may temporarily store data to be stored in at least one of the nonvolatile memory devices 1220-0 to 1220-n. Further, the buffer memory device 1230 may temporarily store the data that is read from at least one of the nonvolatile memory devices 1220-0 to 1220-n. The data, temporarily stored in the buffer memory device 1230, may be transmitted to the host device 1100 or at least one of the nonvolatile memory devices 1220-0 to 1220-n based on the controller 1210.

The nonvolatile memory devices 1220-0 to 1220-n may be used as storage media of the data storage device 1200. The nonvolatile memory devices 1220-0 to 1220-n may be coupled to the controller 1210 through a plurality of channels CH0 to CHn, respectively. One or more nonvolatile memory devices may be coupled to one channel. The nonvolatile memory devices, coupled to each channel, may be coupled to the same signal bus and data bus.

The power supply 1240 may provide power that is inputted through the power connector 1103 to the controller 1210, the nonvolatile memory devices 1220-0 to 1220-n, and the buffer memory device 1230 of the data storage device 1200. The power supply 1240 may include an auxiliary power supply. The auxiliary power supply may supply power to allow the data storage device 1200 to be normally terminated when a sudden power interruption occurs. The auxiliary power supply may include bulk-capacity capacitors that are sufficient to store the needed charge.

The signal connector 1101 may be configured as one or more of various types of connectors, depending on the interface scheme between the host device 1100 and the data storage device 1200.

The power connector 1103 may be configured as one or more of various types of connectors, depending on the power supply scheme of the host device 1100.

FIG. 10 is a diagram, illustrating a data processing system 3000, in accordance with an embodiment. Referring to FIG. 10, the data processing system 3000 may include a host device 3100 and a memory system 3200.

The host device 3100 may be configured in the form of a board, such as a printed circuit board. Although not shown, the host device 3100 may include internal function blocks to perform the function of a host device.

The host device 3100 may include a connection terminal 3110, such as a socket, a slot, or a connector. The memory system 3200 may be mated to the connection terminal 3110.

The memory system 3200 may be configured in the form of a board, such as a printed circuit board. The memory system 3200 may be referred to as a memory module or a memory card. The memory system 3200 may include a controller 3210, a buffer memory device 3220, nonvolatile memory devices 3231 and 3232, a power management integrated circuit (PMIC) 3240, and a connection terminal 3250.

The controller 3210 may control the general operations of the memory system 3200. The controller 3210 may be configured in the same manner as the controller 110 shown in FIGS. 1 and 2.

The buffer memory device 3220 may temporarily store data that is to be stored in the nonvolatile memory devices 3231 and 3232. Further, the buffer memory device 3220 may temporarily store data that is read from the nonvolatile memory devices 3231 and 3232. The data, temporarily stored in the buffer memory device 3220, may be transmitted to the host device 3100 or the nonvolatile memory devices 3231 and 3232 based on the controller 3210.

The nonvolatile memory devices 3231 and 3232 may be used as storage media of the memory system 3200.

The PMIC 3240 may provide the power that is inputted through the connection terminal 3250 to the internal circuits of the memory system 3200. The PMIC 3240 may manage the power of the memory system 3200 based on the controller 3210.

The connection terminal 3250 may be coupled to the connection terminal 3110 of the host device 3100. Through the connection terminal 3250, signals such as commands, addresses, data, and so forth, and power may be transferred between the host device 3100 and the memory system 3200. The connection terminal 3250 may be configured as one or more of various types, depending on an interface scheme between the host device 3100 and the memory system 3200. The connection terminal 3250 may be disposed on a side of the memory system 3200, as shown.

FIG. 11 is a diagram, illustrating a data processing system 4000, in accordance with an embodiment. Referring to FIG. 11, the data processing system 4000 may include a host device 4100 and a memory system 4200.

The host device 4100 may be configured in the form of a board, such as a printed circuit board. Although not shown, the host device 4100 may include internal function blocks to perform the function of a host device.

The memory system 4200 may be configured in the form of a surface-mounted type package. The memory system 4200 may be mounted to the host device 4100 through solder balls 4250. The memory system 4200 may include a controller 4210, a buffer memory device 4220, and a nonvolatile memory device 4230.

The controller 4210 may control the general operations of the memory system 4200. The controller 4210 may be configured in the same manner as the controller 110, shown in FIGS. 1 and 2.

The buffer memory device 4220 may temporarily store data that is to be stored in the nonvolatile memory device 4230. Further, the buffer memory device 4220 may temporarily store data that is read from the nonvolatile memory device 4230. The data, temporarily stored in the buffer memory device 4220, may be transmitted to the host device 4100 or the nonvolatile memory device 4230 based on the controller 4210.

The nonvolatile memory device 4230 may be used as the storage medium of the memory system 4200.

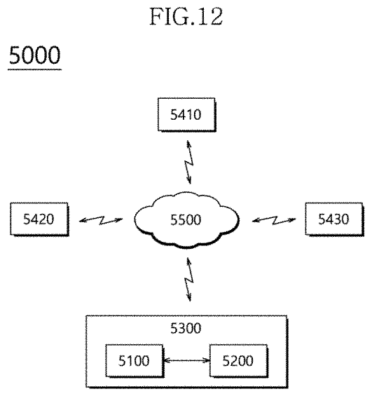

FIG. 12 is a diagram, illustrating a network system 5000 including a data storage device, in accordance with an embodiment. Referring to FIG. 12, the network system 5000 may include a server system 5300 and a plurality of client systems 5410, 5420, and 5430, which are coupled through a network 5500.

The server system 5300 may service data in response to requests from the plurality of client systems 5410 to 5430. For example, the server system 5300 may store the data that is provided by the plurality of client systems 5410 to 5430. In another embodiment, the server system 5300 may provide data to the plurality of client systems 5410 to 5430.

The server system 5300 may include a host device 5100 and a memory system 5200. The memory system 5200 may be configured as the memory system 10 shown in FIG. 1, the data storage device 1200 shown in FIG. 9, the memory system 3200 shown in FIG. 10, or the memory system 4200 shown in FIG. 11.

The above described embodiments of the present invention are intended to illustrate and not to limit the present invention. Various alternatives and equivalents are possible. The invention is not limited by the embodiments described herein. Nor is the invention limited to any specific type of semiconductor device. Another additions, subtractions, or modifications are obvious in view of the present disclosure and are intended to fall within the scope of the appended claims.

What is claimed is:

1. A data storage device comprising:
a storage including a plurality of memory cells; and
a controller configured to map a logical address of a host device on a first physical address of the storage to perform data exchanges with respect to the storage,
wherein the controller comprises an address error management component, and
wherein the address error management component generates a first checker based on the first physical address, transmits the first checker with the first physical address to the storage, and remaps the logical address on a second physical address when an address error occurs in the first physical address based on an address error check information that is transmitted from the storage.

2. The data storage device of claim 1, wherein the first physical address is transmitted for a plurality of cycles by a plurality of bits, and
wherein the address error management component is configured to include the first checker in an unused bit of the first physical address and configured to transmit the first checker along an address transmission cycle.

3. The data storage device of claim 1, wherein the controller transmits a status read command to the storage after transmitting a write command and the first physical address, including the first checker, to the storage, and
wherein the address error check information is transmitted as a response signal of the status read command.

4. The data storage device of claim 3, wherein the response signal comprises bits of a status information, and
wherein the address error check information is included in at least a portion of the status information.

5. The data storage device of claim 1, wherein the first physical address is transmitted for a plurality of cycles by a plurality of bits,
wherein the address error management component performs a first logic operation of an address bit in a same bit position for each of the cycles, and
wherein the address error management component sets a parity bit that is generated from the first logic operation as the first checker.

6. The data storage device of claim 1, wherein the controller is configured to store the first physical address and a changed address as a log information by transmitting the changed address, through the address error, to the storage.

7. A data storage device comprising:
a controller configured to map a logical address of a host device on a first physical address of a storage in response to a command process request of the host device and configured to transmit a first checker, which is generated based on the first physical address, transmitting the first checker with the first physical address to the storage; and
the storage including a plurality of memory cells and configured to compare the first checker with a second checker to generate an address error check information,
wherein the second checker is generated based on the first physical address, and
wherein the controller remaps the logical address on a second physical address when an address error occurs in the first physical address, which is determined based on the address error check information that is transmitted from the storage.

8. The data storage device of claim 7, wherein the first physical address is transmitted for a plurality of cycles by a plurality of bits, and
wherein the controller is configured to include the first checker in an unused bit of the first physical address and configured to transmit first checker along an address transmission cycle.

9. The data storage device of claim 7, wherein the controller transmits a status read command to the storage after transmitting a write command and the first physical address, including the first checker, to the storage, and
wherein the address error check information is transmitted as a response signal of the status read command.

10. The data storage device of claim 9, wherein the response signal comprises a plurality of bits of a status information, and
wherein the address error check information is included in at least a portion of the status information.

11. The data storage device of claim 7, wherein the first checker and the second checker are generated in a same manner.

12. The data storage device of claim 11, wherein the first physical address is transmitted for a plurality of cycles by a plurality of bits,
wherein the controller and the storage perform a first logic operation of an address bit in a same bit position for each of the cycles, and
wherein the controller and the storage generate the first checker and the second checker from the first logic operation.

13. The data storage device of claim 7, wherein the storage transmits an address, changed by the address error, to the controller, and
wherein the controller is configured to store the first physical address and the changed address as a log information.

14. A method of operating a data storage device, the data storage device including a storage and a controller configured to map a logical address of a host device on a first physical address of the storage to perform data exchanges with respect to the storage, method comprising:
generating, by the controller, a first checker based on the first physical address;
including the first checker in the first physical address and transmitting, by the controller, the first physical address with the first checker to the storage;
generating, by the storage, a second checker based on the first physical address that is received from the controller;
transmitting, by the storage, an address error check information, which is generated by comparing the first checker with the second checker, to the controller;
identifying, by the controller, whether an address error is generated, which is determined based on the address error check information; and
remapping, by the controller, the logical address on a second physical address when the address error is generated.

15. The method of claim 14, wherein the first physical address is transmitted for a plurality of cycles by a plurality of bits, and
wherein the controller is configured to include the first checker in an unused bit of the first physical address and configured to transmit the first checker along an address transmission cycle.

16. The method of claim 14, further comprising;
transmitting, by the controller, a status read command to the storage; and
transmitting, by the storage, the address error check information as a response signal of the status read command.

17. The method of claim 16, wherein the response signal comprises a plurality of bits of a status information, and
wherein the address error check information is included in at least a portion of the status information.

18. The method of claim 14, wherein the first physical address is transmitted for a plurality of cycles by a plurality of bits, and
wherein generating, by the controller, the first checker comprises performing a first logic operation of an address bit in a same bit position for each of the cycles, and
wherein setting, by the controller, a parity bit that is generated from the first logic operation as the first checker.

19. The method of claim 14, wherein the first physical address is transmitted for a plurality of cycles by a plurality of bits,
wherein generating, by the controller, the second checker comprises performing a first logic operation of an address bit in a same bit position for each of the cycles, and
wherein setting, by the controller, a parity bit that is generated from the first logic operation as the second checker.

20. The method of claim 14, further comprising:
transmitting, by the storage, an address that is changed by the address error to the controller; and
storing, by the controller, the first physical address and the changed address as a log information.
